(19) United States
(12) Patent Application Publication
(10) Pub. No.: US 2013/0224972 A1
(43) Pub. Date: Aug. 29, 2013

(54) UNIVERSAL SERIAL BUS DEVICE

(71) Applicant: PANTECH CO., LTD., (US)

(72) Inventor: Chang Jin YANG, Seoul (KR)

(73) Assignee: PANTECH CO., LTD., Seoul (KR)

(21) Appl. No.: 13/693,584

(22) Filed: Dec. 4, 2012

(30) Foreign Application Priority Data
Feb. 27, 2012 (KR) 10-2012-0019655

(51) Int. Cl. H01R 13/44

(52) U.S. Cl. CPC H01R 13/44
USPC 439/131

(57) ABSTRACT

Provided is a universal serial bus (USB) device including a main body in which a printed circuit board (PCB) is housed, and a USB terminal unit with at least two hinge portions rotatably connected with the main body to electrically connect with the PCB according to a rotation of the USB terminal unit.

### CROSS-REFERENCE TO RELATED APPLICATION

This application claims priority from and the benefit of Korean Patent Application No. 10-2012-0019655 filed on Feb. 27, 2012, which is hereby incorporated by reference for all purposes as if fully set forth herein.

### BACKGROUND

1. Field

Exemplary embodiments of the present invention relate to a universal serial bus (USB) device, and more particularly, to a USB device that controls an electrical connection between a main printed circuit board (PCB) and a terminal.

2. Discussion of the Background

Developments in information technology (IT) may provide an environment to enable transmission of information through a portable terminal or a computer. More particularly, as various services based on digitalization and the Internet may be united, the respective services may tend toward a wider bandwidth and/or higher speeds of transmission or reception. As a result, significance of a network technology may be increasing.

According to the development in the network technology, text data along with audio and video data may be transmitted in real time by constructing a network. Here, the integrated service digital network (ISDN), a cable modem, and the like may be used in a communication network.

However, since the cable modem may be associated with a high cost for installation and use, and may be limited in locations of use, a wireless modem may be used instead of the cable modem. Here, the wireless modem may collectively refer to devices wirelessly accessing the Internet using a personal mobile terminal, such as a laptop computer or a personal digital assistant (PDA), to perform data transmission or phone-calling through a wireless public network.

In general, the wireless modem may be connected to a terminal device through a universal serial bus (USB) for convenient carriage and installation. A general USB modem may include a terminal, a main printed circuit board (PCB), and a sub PCB. The terminal and the sub PCB may be connected, and the sub PCB and the main PCB may be connected through a wire to form an electrical connection. Here, a connection between the terminal and the sub PCB, and a connection between the sub PCB and the main PCB, may be implemented by soldering or other comparable methods.

Therefore, an extra space may be occupied by the sub PCB and the wire in the general USB modem, which may increase the size of the general USB modem. In addition, manufacturing processes of a product may be increased, which may lead to an increase in defect tests for each process. As a result, the manufacturing of these devices may become more complicated and more expensive.

### SUMMARY

Exemplary embodiments of the present invention provide a universal serial bus

(USB) device to establish an electrical connection between a printed circuit board (PCB) and a terminal according to a movement of the USB device.

Additional features of the invention will be set forth in the description which follows, and in part will be apparent from the description, or may be learned by practice of the invention.

Exemplary embodiments of the present invention provide a USB device including a main body to house a printed circuit board (PCB); and a USB terminal unit rotatably connected to the main body, in which the USB terminal unit includes a terminal including a first terminal portion and a second terminal portion; and a hinge unit connected to the USB terminal unit and the main body to rotate the USB terminal unit with respect to the main body.

Exemplary embodiments of the present invention provide a USB device including a main body to house a PCB; and a USB terminal unit rotatably connected to the main body via at least two hinge portions, in which, when the USB terminal unit is rotated from a closed state to an opened state, the USB terminal unit contacts the PCB to establish an electrical connection.

Exemplary embodiments of the present invention provide a USB device including a main body to house a PCB; and a USB terminal unit rotatably connected to the main body, and including at least two hinge portions, in which a first hinge portion connects to the USB terminal unit and a second hinge portion connects to the main body, and the USB terminal unit is rotatable from a closed state to an opened state to establish an electrical connection between the USB terminal and the PCB.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a closed state of a universal serial bus (USB) modem device according to an exemplary embodiment of the present invention.

FIG. 2 is a diagram illustrating an opened state of the USB modem device shown in FIG. 1.

FIG. 3 is an exploded perspective view of a USB terminal unit shown in FIG. 1.

FIG. 4 is a diagram illustrating operation according to a phase of a hinge portion of a USB terminal unit according to an exemplary embodiment of the present invention.

FIG. 5A, FIG. 5B, FIG. 5C, and FIG. 5D are diagrams illustrating states of a terminal and a main printed circuit board (PCB) according to rotation of a USB terminal unit according to an exemplary embodiment of the present invention.

FIG. 6 is a diagram illustrating the USB terminal unit equipped with a stopper according to an exemplary embodiment of the present invention.

FIG. 7 is a sectional view illustrating a structure of a USB modem device according to an exemplary embodiment of the present invention.

FIG. 8 is a diagram illustrating a USB terminal unit shown in FIG. 7 being opened by rotating with respect to a main body.

FIG. 9 is a sectional view illustrating a structure of a USB modem device according to an exemplary embodiment of the present invention.

FIG. 10 is a diagram illustrating a USB terminal unit shown in FIG. 9, being opened by rotating with respect to a main body.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that when an element is referred to as being “connected to” another element, it can be directly connected to the other element, or intervening elements may be present. Further, it will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The following description provides descriptions of various exemplary embodiments of the present invention but the scope of disclosure is not limited thereto. Also, the following description forms part of the detailed description of the illustrated exemplary embodiments.

However, in describing exemplary embodiments, if detailed descriptions of related disclosed art or configuration may make the subject matter of the present invention more obscure, they may be omitted.

Hereinafter, a universal serial bus (USB) device according to exemplary embodiments of the present invention will be explained as a USB modem device; however, aspects of the invention need not be limited to the explanation contained herein. For example, aspects of the invention may be applicable to USB devices in which a USB terminal has a rotatable structure, such as a USB memory and a USB-type terminal. Furthermore, aspects of the invention may be applicable to connectors having a rotatable structure.

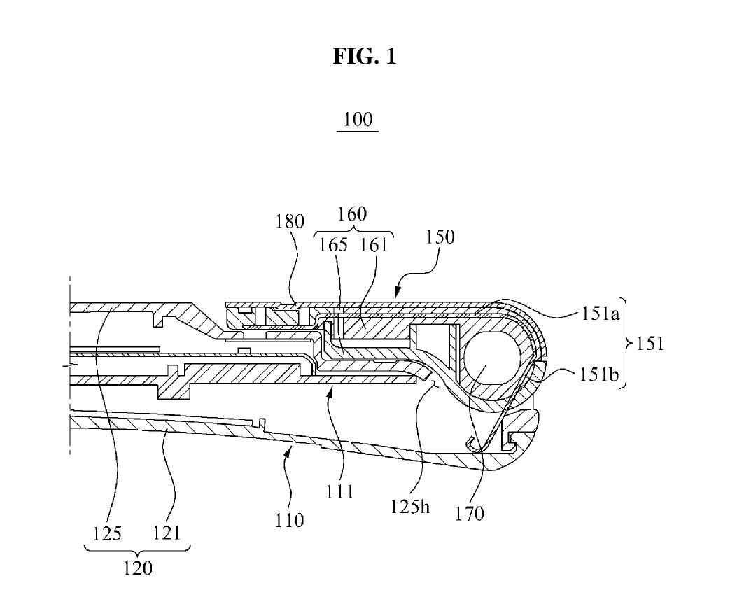

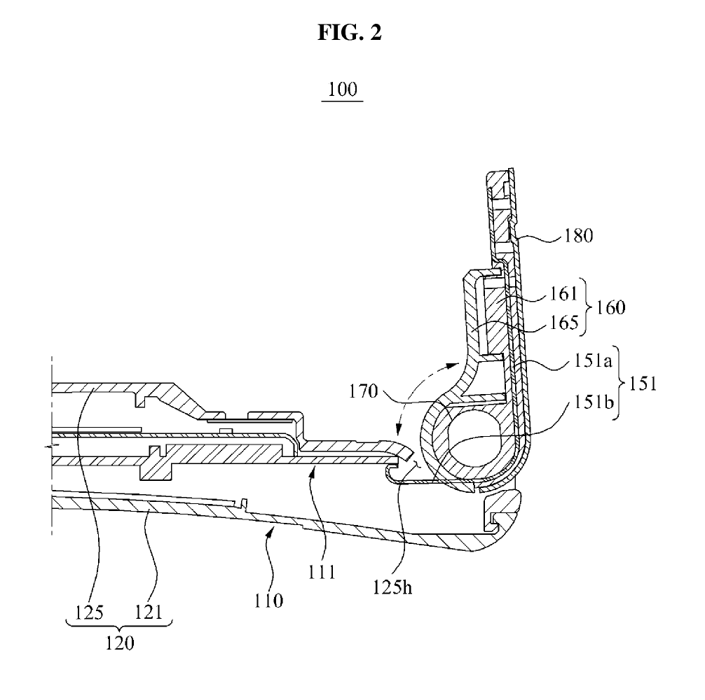

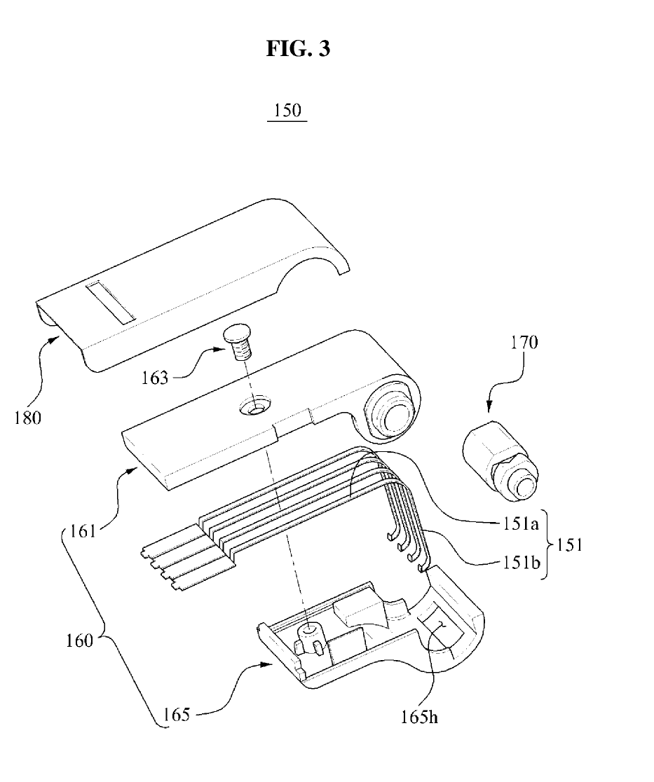

FIG. 1 is a diagram illustrating a closed state of a USB modem device 100 according to an exemplary embodiment of the present invention. FIG. 2 is a diagram illustrating an opened state of the USB modem device 100 shown in FIG. 1. FIG. 3 is an exploded perspective view of a USB terminal unit 150 shown in FIG. 1.

Referring to FIG. 1 and FIG. 2, the USB modem device 100 may include a main body 110 equipped with a main printed circuit board (PCB) 111 and configured to perform an operation and the like. However, aspects of the invention are not limited thereto, such that the USB modem device 100 need not be a modem device but may be a USB device, and a PCB included in the main body may not be a main PCB. The USB terminal unit 150 is equipped with a terminal 151, which may be rotatably connected to the main body 110. Here, electrical connection between the terminal 151 and the main PCB 111 may be determined by rotation of the USB terminal unit 150 with respect to the main body 110, so that exchange of electrical signals may be achieved between the terminal 151 and the main PCB 111. More specifically, the USB terminal unit 150 may rotate with respect to the main body 110 from a first state or a closed state of FIG. 1 to a second state or an opened state of FIG. 2 to establish an electrical connection.

The foregoing components will be described, respectively. As shown in the exploded perspective view of FIG. 3, the USB terminal unit 150 may include the terminal 151 in which a plurality of terminals are arranged in parallel, a terminal connecting body 160 to which a first part of the terminal 151 is fixedly connected and a second part of the terminal 151 is movably connected, a hinge portion 170 rotatably connecting the terminal connecting body 160 to the main body 110, and a unit guide 180 connected to the terminal connecting body 160.

The terminal connecting body 160 may include an upper case 161 to which the first part of the terminal 151 may be fixed, and a lower case 165 connected with the upper case 161 and provided with a through hole 165h, in which an end portion of the terminal 151 may be inserted. Further, the part of the terminal 151 may be connected to the lower case 165. Hereinafter, however, the exemplary embodiment in which the terminal 151 is connected to the upper case 161 will be described.

The terminal 151 may be made of a conductive material having tension and electrical conductivity. As shown in FIG. 1, FIG. 2, and FIG. 3, the terminal 151 may have a substantial L shape. In more detail, the terminal 151 may include a terminal fixed portion 151a fixed to the upper case 161, and a terminal movable portion 151b extended from the terminal fixed portion 151a to enter the main body 110 through the through hole 165h formed on the lower case 165. Here, the terminal fixed portion 151a and the terminal movable portion 151b may be bent at a reference angle with respect to each other. The terminal movable portion 151b may be in a linear shape or curved shape.

The terminal fixed portion 151a of the terminal 151 may be disposed horizontally in the upper case 161 and the lower case 165. The terminal movable portion 151b may be inserted in the main body 110, passing through the lower case 165.

The terminal fixed portion 151a and the terminal movable portion 151b of the terminal 151 may extend to form a reference angle with respect to each other. The reference angle may be smaller than a rotational angle of the USB terminal unit 150, that is, a preset phase of the hinge portion 170. According to an exemplary embodiment, the reference angle may be an acute angle which may be smaller than 90°.

As will be described hereinafter, if the USB terminal unit 150 rotates by about 90° using the hinge portion 170, the terminal 151 may be rotated correspondingly. The terminal 151 may be rotated by the same degree as the USB terminal unit 150. If the terminal 151 forms an acute angle, the terminal movable portion 151b may be brought into contact with the main PCB 111 of the main body 110, and may push a contact surface of the main PCB 111 with a reference amount of pressure. As a result, a secure contact between the terminal movable portion 151b and the main PCB 111 may be maintained.

Here, due, at least in part, to the tension of the terminal 151, contact between the main PCB and a portion of the terminal 151, such as an end portion, may be achieved. In addition, the terminal 151 may be made of an elastic material, but is not limited thereto. Whereas the terminal fixed portion 151a is fixed to the upper case 161, the terminal movable portion 151b may be movable. Therefore, the terminal 151, more particularly, the terminal movable portion 151b may have tension to enable contact between the main PCB 111 and the end portion of the terminal 151.

Referring to FIG. 2, to secure contact between the terminal movable portion 151a of the terminal 151 and the main PCB 111, one end portion of the terminal movable portion 151b may be curved, for example, into a flattened-U shape or other comparable shapes. In this case, the main PCB 111 and the end portion of the terminal movable portion 151b may make a surface contact rather than a line contact to secure an electrical connection.

Although not shown, a contact terminal (not shown) may be provided to the terminal movable portion 151b to contact the main PCB 111 to increase reliability in the contact between the main PCB 111 and the terminal movable portion 151b. The contact terminal may be made of a conductive material and disposed at an end portion of the terminal movable portion 151b, the end portion which may contact the main PCB 111.

The upper case 161 and the lower case 165 may cover the terminal 151 from an upper part and a lower part, respectively. The upper case 161 may include the hinge portion 170. However, not limited to the foregoing structure, the hinge portion 170 may be connected to the lower case 165 or connected between the upper case 161 and the lower case 165. The upper case 161 and the lower case 165 may be coupled by a screw 163.

The terminal 151 may be connected to the upper case 161, and disposed between the upper case 161 and the lower case 165. The upper case 161 and the lower case 165 may be connected by a screw or screw-connected. For example, the terminal 151 may be fixed to the upper case 161 by molding or by bonding using an adhesive tape or adhesive agent. In addition, the terminal 151 may be fixed to the lower case 165 by molding or by bonding. However, aspects of the invention need not be limited thereto. For example, the terminal 151 may be connected with the screws to the upper case 161 or the lower case 165. Further, the upper case 161 and the lower case 165 may be connected to teach other by molding or bonding with tape or adhesive.

However, to increase reliability in connection between the terminal 151 and an external device (not shown) when the terminal 151 is connected to the upper case 161 or the lower case 165, an end portion of the terminal fixed portion 151a may be curved as shown in FIG. 3. For example, if the terminal fixed portion 151a is connected to the upper case 161 or the lower case 165 by a molding process, the connection may be facilitated if the terminal fixed portion 151a has a curved end. Furthermore, connection reliability between the curved end and the external device may be increased.

The lower case 165 may include the through hole 165h to allow insertion of a part of the terminal 151, which may be connected to the upper case 161. Further, the terminal 151 may extend through the through hole 165h included in the lower case 165. The lower case 165 may be shaped corresponding to a shape of the upper case 161, which may be curved to mount the hinge unit 170, so that the upper case 161 and the lower case 165 may fit each other.

The hinge unit 170 may be fixed to the upper case 161 with one part and fixed to a sidewall of the main body 110 with another part, so that the USB terminal unit 150 may rotate with respect to the main body 110. Additionally, according to exemplary embodiments of the present invention, a wire used to electrically connect a terminal with a main PCB in a related-art USB device may be omitted. Therefore, the USB terminal unit 150 may include two hinge portions (not shown) to rotate the terminal 151. That is, whereas a USB terminal unit according to the related art is configured to mount a hinge unit at one side and a wire passing through another side, the USB terminal unit 150 according to exemplary embodiments may include the hinge portions on both sides. Further, if a slim-type hinge portion is applied, the USB terminal unit 150 may be further slimmed to reduce thickness of the USB device.

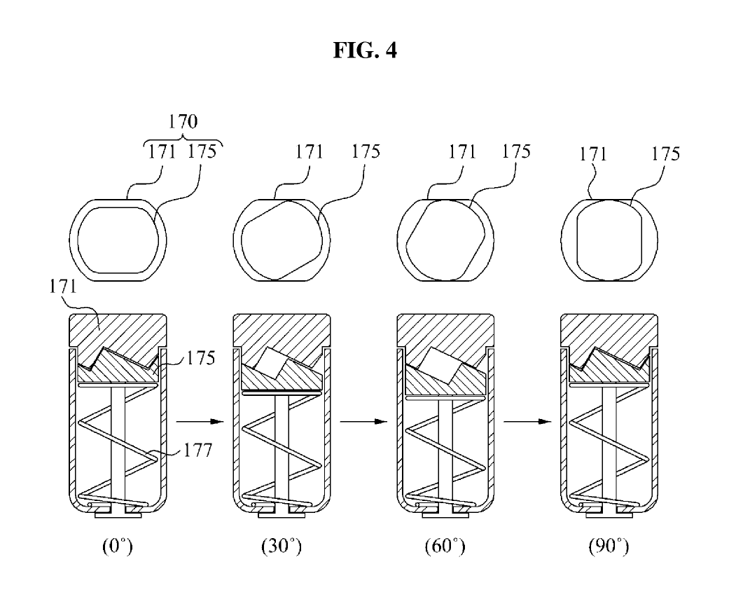

FIG. 4 is a diagram illustrating operation according to a phase of a hinge portion 170 of a USB terminal unit according to an exemplary embodiment of the present invention.

Referring to FIG. 4, the hinge portion 170 may include a fixed part 171 connected to a side of the main body 110, and a rotational part 175 connected to the upper case 161 to be rotatable with respect to the fixed part 171. The rotational part 175 may be connected to the side of the main body 110 while the fixed part 171 may be fixed to the upper case 161.

The hinge portion 170 including the fixed part 171, the rotational part 175, which may have a phase of about 90°, and a cam structure to fix a position of the USB terminal unit 150 with respect to the main body 110 within a range from about 0° to about 90°. However, aspects are not limited thereto, such that the cam structure may fix a position of the USB terminal unit 150 at a greater angle, such as 100° or 110°.

Referring to FIG. 4, if the rotational part 175 rotates with respect to the fixed part 171, the rotational part 175 and the fixed part 171 may be engaged with each other to maintain the engagement within the range from about 0° to about 90°. Here, an elastic member 177 may be mounted to the rotational part 175 to push the rotational part 175 toward the fixed part 171 to maintain the engagement between the rotational part 175 and the fixed part 171.

The unit guide 180 may be connected to an upper part of the upper case 161, as shown in FIG. 3. The unit guide 180 may protect the terminal 151, and also reduce a likelihood of the USB terminal unit 150 from being inserted in a reverse direction when the USB terminal unit 150 is inserted in a port of a terminal device.

The main body 110 may include the main PCB 111 and a main body case 120 in which the main PCB 111 is built, as shown in FIG. 1 and FIG. 2.

The main body case 120 may include an upper main body 125 and a lower main body 121, which may be coupled into the main body case 1. The upper main body 125 may be shaped to correspond to a shape of the USB terminal unit 150. The fixed part 171 of the hinge portion 170 may be connected to a sidewall of the upper main body 125.

Therefore, as shown in FIG. 1, the USB terminal unit 150 may maintain a folded state or a closed state with respect to the main body when an electrical connection may not formed between the terminal 151 of the USB terminal unit 150 and the main PCB 111 of the main body 110. Conversely, as shown in FIG. 2, when the electrical connection is formed between the terminal 151 and the main PCB 111, the USB terminal unit 150 may rotate with respect to the main body 110 to maintain an unfolded state or an open state with respect to the main body 110.

In addition, the upper main body 125 may include a terminal hole 125h to allow insertion of a portion of a terminal movable portion 151b. If the terminal movable portion 151b of the terminal 151 is moved by rotation of the USB terminal unit 150, the terminal movable portion 151b may move within the terminal hole 125h. As a result, the electrical connection between the terminal 151 and the main PCB 111 may be achieved.

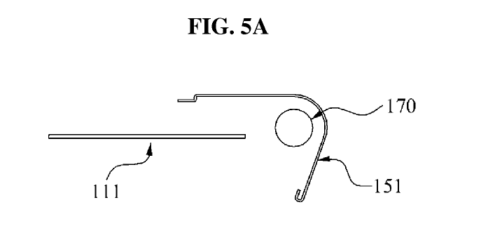

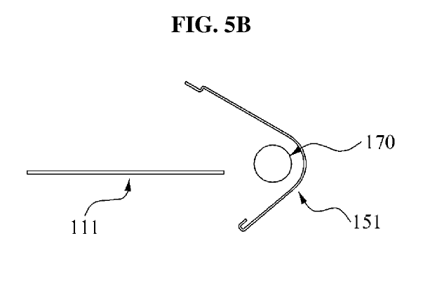

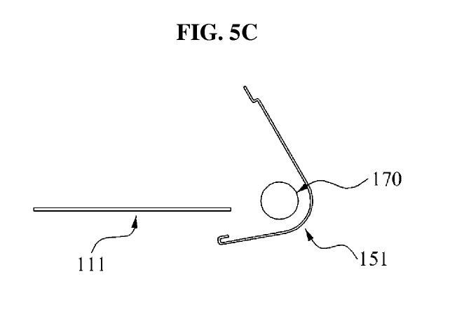

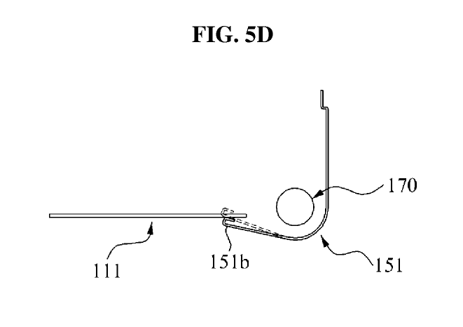

Hereinafter, an operation for connecting the terminal 151 of the USB terminal unit 150 to the main PCB 111 of the main body 110 will be described with reference to FIG. 5A, FIG. 5B, FIG. 5C and FIG. 5D.

FIG. 5A, FIG. 5B, FIG. 5C, and FIG. 5D are diagrams illustrating states of a terminal 151 and a main PCB 111 according to rotation of a USB terminal unit 150 according to an exemplary embodiment of the present invention.

FIG. 5A shows that the USB terminal unit 150 maintaining the closed state with respect to the main body 110, that is, an angle of about 0°. In this state, since connection between the terminal movable portion 151b of the terminal 151 and the main PCB 111 may not formed, exchange of electrical signals may not performed.

FIG. 5B and FIG. 5C show the USB terminal unit 150 opening with respect to the main body 110. That is, the USB terminal unit 150 may be opened by about 30° and about 60°, respectively, by rotation of a hinge portion 170 from the state shown in FIG. 5A .

FIG. 5D shows the USB terminal unit 150 maintaining a fully opened state with respect to the main body 110. More specifically, the USB terminal unit 150 may be rotated by about 90° or a reference angle by rotation of the hinge portion 170. Accordingly, the terminal movable portion 151b of the terminal 151 and the main PCB 111 may maintain contact with each other. Here, as aforementioned, a position of the USB terminal unit 150 with respect to the main body 110 may be maintained by a cam structure of the hinge portion 170.

In addition, as aforementioned, the terminal 151 may be bent by an acute angle. In an example, if the hinge portion 170 is rotated by about 90°, the terminal movable portion 151b of the terminal 151 may contact the main PCB 111 and maintain tension with respect to the main PCB 111 as shown in FIG. 5D. Therefore, the contact between the main PCB 111 and the end of the terminal 151 may be maintained.

Further, if the phase of the hinge portion 170 is about 90°, the main PCB 111 and the terminal movable portion 151b of the terminal 151 may share an overlapping section ranging from about 0.8 mm to about 1.1 mm due, at least in part, to the tension of the terminal 151. Consequently, the contact may be maintained.

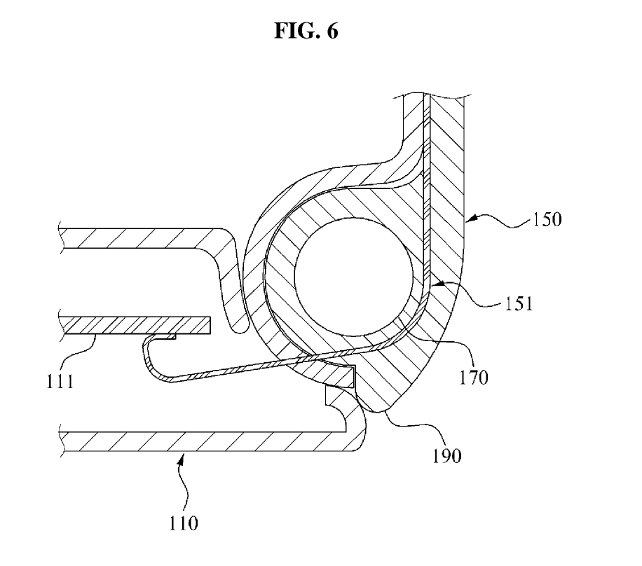

FIG. 6 is a diagram illustrating the USB terminal unit 150 shown in FIG. 1 equipped with a stopper 190. Referring to FIG. 6, the USB terminal unit 150 may further include the stopper 190 configured to restrict a rotational angle with respect to the main body 110. More specifically, since the stopper 190 may protrude out of the upper case 161, if the USB terminal unit 150 rotates with respect to the main body 110 by about 90°, the stopper 190 may be caught by the lower body 121 of the main body 110. Therefore, the position of the USB terminal unit 150 with respect to the main body 110 may be maintained even with application of an external force. Also, a likelihood of damage of the terminal 151 and the main PCB 111 caused by excessive rotation may be reduced.

Thus, according to exemplary embodiment of the present invention, a wire or a sub PCB used in the related art to connect the terminal 151 and the main PCB 111 may be omitted. More specifically, the electrical connection between the main PCB 111 and the terminal 151 may be controlled by rotation of the USB terminal unit 150 with respect to the main body 110.

Moreover, the aforementioned structure may simplify the manufacturing process, for example by omitting a soldering defect test and the like, which may reduce manufacturing costs. In addition, since some of the wires and sub PCB may be omitted, the material cost may be reduced. Furthermore, since some of the wires and the sub PCB may be omitted, the USB terminal unit 150 may be slimmer in size, which may make the entire device slimmer. Other components may be added to the main body 110 using space generated by slimming of the USB terminal unit 150. Therefore, structuring of the main body 110 may be facilitated. Furthermore, reduction in size and thickness of the main body 110 may reduce an entire length of the device.

Although the hinge portion according to exemplary embodiments is explained to have the phase of about 90°, the phase is not limited thereto. For example, the phase may be about 180° or other reference angles. In this case, the USB terminal unit may be opened in various angles, such as by 90° and 180°, with respect to the main body. If the USB terminal unit is opened by 90° or more with respect to the main body, the opened state of the USB terminal unit may not be maintained due to a recovery force of the terminal since the terminal fixed portion and the terminal movable portion may form an angle of 90° or smaller. Therefore, the hinge portion may be configured to be fixed at reference positions, for example at positions corresponding to 90° and 180°. However, aspects need not be limited thereto such that the hinge portion may fix a position at different angles, such as 45°, 135°, or 270°. A locking member may be further provided to fix the USB terminal unit in the opened state.

According to exemplary embodiments of the present invention, if the USB terminal unit is rotated by 90° or more repeatedly, the terminal may become fatigued and damaged. Therefore, the terminal fixed portion and the terminal movable portion of the terminal may exemplarily form an angle similar to the phase of the hinge portion. That is, if the phase of the hinge portion is about 90°, the terminal may form an angle of 90° or smaller. If the phase of the hinge portion is about 180°, the terminal may form an angle of 180° or smaller. In this case, if the USB terminal unit is rotated by about 180° with respect to the main body through the operation of the hinge portion, the terminal and the main PCB may be electrically connected with each other. Here, by reducing the angle between the terminal fixed portion and the terminal movable portion, contact between the terminal and the main PCB may be maintained even with repeated operations.

Hereinafter, a USB modem device according to an exemplary embodiment of the present invention will be described. However, the same elements as in the previous embodiment will not be described again.

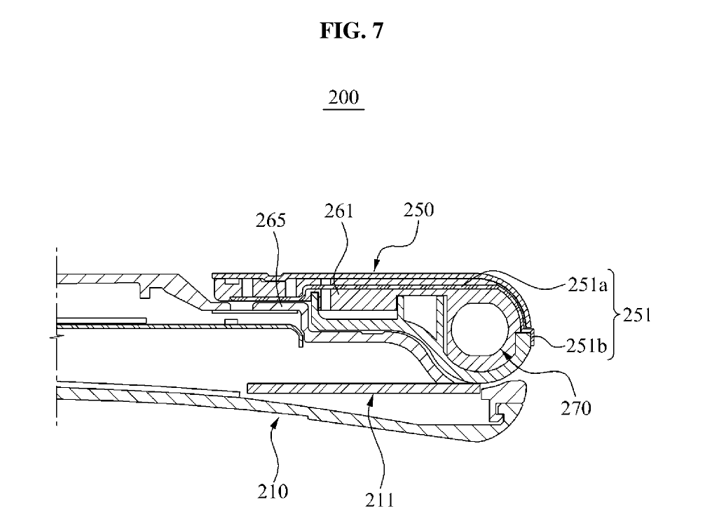

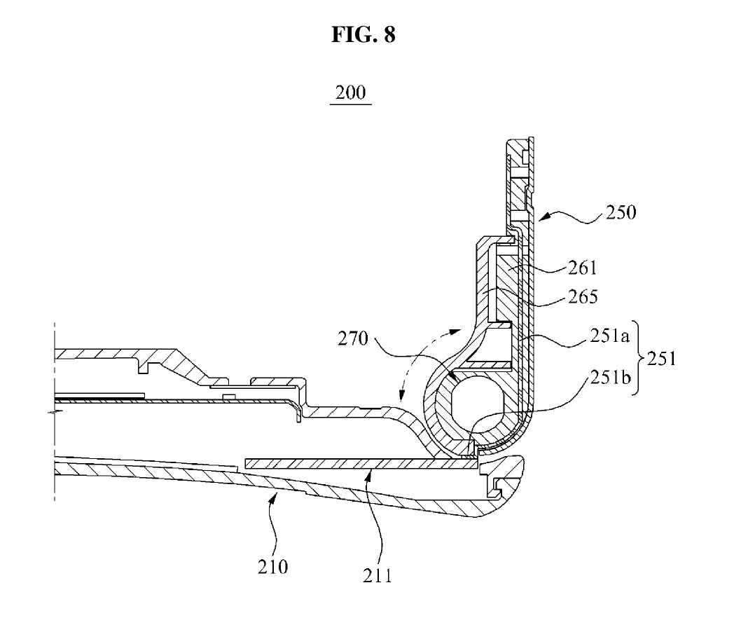

FIG. 7 is a sectional view illustrating a structure of a USB modem device 200 according to an exemplary embodiment of the present invention. FIG. 8 is a diagram illustrating a USB terminal unit 250 shown in FIG. 7, being opened by rotating with respect to a main body.

As shown in the drawings, the USB modem device 200 may include a main body 210 in which a main PCB 211 is built, and a USB terminal unit 250 that includes a terminal 251.

A contact structure between the main PCB 211 and the terminal 251 may be different from in the previous embodiments.

The terminal 251 may include a first terminal fixed portion 251a and a second terminal fixed portion 251b extended from the first terminal fixed portion 251a. The second terminal fixed portion 25 lb may be exposed to the outside through a connection part between an upper case 261 and a lower case 265 mounting a hinge portion 270. Further, the second terminal fixed portion 251b may be disposed at an outer surface of the lower case 265. The second terminal fixed portion 251b may be brought into contact with the main PCB 211 by rotation of the USB terminal unit 250. Although the second terminal fixed portion 25 lb may be disposed at the outer surface of the lower case 265, the second terminal fixed portion 25 lb may also be disposed at an outer surface of the upper case 261.

Referring to FIG. 8, if the USB terminal unit 250 is rotated with respect to the main body 210 by rotation of the hinge portion 270, the second terminal fixed portion 251b of the terminal 251 may come into contact with an upper surface of the main PCB 211. Accordingly, the electrical connection between the terminal 251 and the main PCB 211 may be achieved.

Although not shown, the main PCB 211 may include a tension member disposed in the main body 210 to apply tension, which may increase reliability in contact between the main PCB 211 and the terminal 251.

In addition, although not shown, the upper case 261 through which the second terminal fixed portion 251b may be exposed may include a cover member (not shown) to selectively cover the second terminal fixed portion 251b. Referring to FIG. 7, the cover member may cover and protect the second terminal fixed portion 251b. However, if the USB terminal unit 250 rotates with respect to the main body 210, the cover member may interfere with the main body 210 and pushed, and the second terminal fixed portion 251b exposed out of the cover member may be inserted in the main body 210 and brought into contact with the main PCB 210.

Thus, according to exemplary embodiments of the present embodiment, since the USB terminal unit 250 may rotate within a reference range of angles with respect to the main body 210, the electrical connection between the terminal 251 of the USB terminal unit 250 and the main PCB 211 of the main body 210 may be controlled.

Hereinafter, a USB modem device according to still an exemplary embodiment of the present invention will be described. However, the same elements as in the previous embodiments will not be described again.

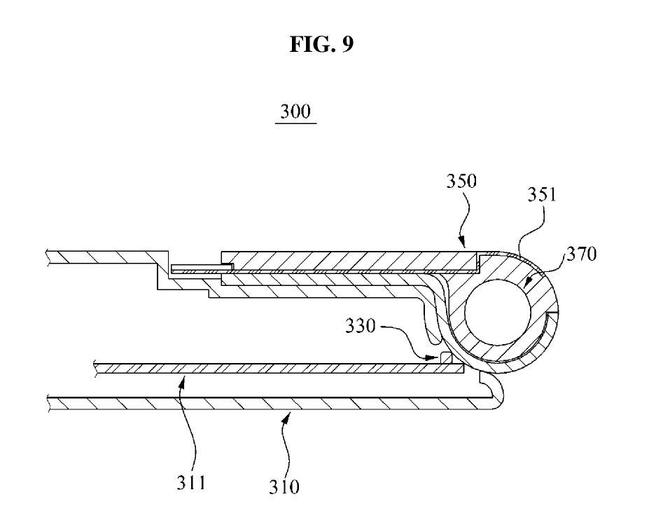

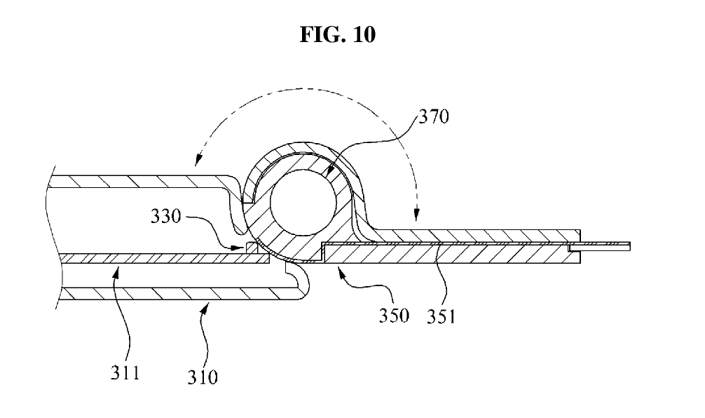

FIG. 9 is a sectional view illustrating a structure of a USB modem device 300 according to an exemplary embodiment of the present invention. FIG. 10 is a diagram illustrating a USB terminal unit 350 shown in FIG. 9, being opened by rotating with respect to a

As shown in the drawings, the USB modem device 300 may include the main body 310 in which a main PCB 311 is built, and the USB terminal unit 350 that includes a terminal 351. A PCB connection member 330, which may be tensional and electrically conductive, may be disposed at one side of the main PCB 311. If the USB terminal unit 350 is rotated by a reference angle around a hinge portion 370, an end of the terminal 351 and the PCB connection member 330 may contact each other to form an electrical connection between the terminal 351 and the main PCB 311.

However, the hinge portion 370 according to exemplary embodiments of the present embodiment has a phase of about 180°. That is, as shown in FIG. 9, if the phase of the hinge portion 370 is 0° or the USB modem device 300 is in the closed state, the electrical connection between the terminal 351 and the main PCB 311 may not be formed.

As shown in FIG. 10, if the phase of the hinge portion 370 is about 180°, more specifically, if the hinge portion 370 is rotated by about 180° and opened with respect to the main body 310, the terminal 351 and the PCB connection member 330 of the main PCB 311 may contact each other to form the electrical connection.

In addition, although not shown, the USB terminal unit 350 through which the terminal 351 is exposed may include a cover member (not shown) to cover the terminal 351. In a state of FIG. 9, the cover member may cover and protect the terminal 351. However, if the USB terminal unit 350 rotates with respect to the main body 310, the cover member may interfere with the main body 310 and pushed. Further, the terminal 351 exposed out of the cover member may be inserted in the main body 310 and brought into contact with the PCB connection member 330.

Thus, according to exemplary embodiments of the present invention, the electrical connection between the terminal 351 of the USB terminal unit 350 and the main PCB 311 of the main body 310 may be controlled by rotation of the USB terminal unit 350 with respect to the main body 310.

Although the aforementioned exemplary embodiments describe the phase of the hinge portion as being about 90° and 180°, this is not limited thereto. More specifically, the phase of the hinge portion may be set to other angles, and the opened state and closed state of the USB terminal unit with respect to the main body may be accordingly controlled.

According to exemplary embodiments of the present invention, an electrical connection between a main printed circuit board (PCB) and a terminal may be controlled by rotation of a USB terminal unit with respect to a main body, without a wire, a sub PCB, and the like to connect the terminal with the main PCB.

Additionally, according to exemplary embodiments of the present invention, one or more steps of a manufacturing process (e.g., soldering defect test) may be simplified to reduce manufacturing costs. Also, material cost may be reduced by omitting the wire and the sub PCB in the manufacturing process.

In addition, according to exemplary embodiments of the present invention, the USB device may become slimmer and more compact since the wire and a sub PCB may be omitted.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A universal serial bus (USB) device, comprising:
a main body to house a printed circuit board (PCB); and
a USB terminal unit rotatably connected to the main body,
wherein the USB terminal unit comprises:
a terminal comprising a first terminal portion and a second terminal portion; and
a hinge unit connected to the USB terminal unit and the main body to rotate the USB terminal unit with respect to the main body.

2. The USB device of claim 1, wherein the USB terminal unit further comprises a terminal connecting body, the terminal connecting body comprising a first case, a second case connected to the first case, and a through hole through which the terminal extends.

3. The USB device of claim 1, wherein the first terminal portion is fixed to the USB terminal unit and the second terminal portion is moveable with respect to the USB terminal unit.

4. The USB device of claim 2, wherein the second terminal portion extends from the first terminal portion into the main body through the through hole.

5. The USB device of claim 1, wherein the second terminal portion and the first terminal portion are bent at a reference angle with respect to each other.

6. The USB device of claim 5, wherein the reference angle is smaller than a preset phase of the hinge portion.

7. The USB device of claim 6, wherein, when the hinge portion is rotated to the preset phase, the second terminal portion contacts the PCB.

8. The USB device of claim 1, wherein the terminal comprises a conductive material having tension and electrical conductivity.

9. The USB device of claim 1, wherein the terminal comprises an elastic material.

10. The USB device of claim 1, wherein the USB terminal unit rotates from a closed state to an opened state with respect to the main body to establish an electrical connection.

11. The USB device of claim 1, wherein a portion of the second terminal portion is curved.

12. The USB device of claim 11, wherein the PCB contacts the portion of the second terminal portion when the USB terminal unit is in an opened state with respect to the main body.

13. The USB device of claim 1, wherein the USB terminal unit comprises at least two hinge portions.

14. The USB device of claim 1, wherein the main body is rotatably connected to the main body via at least two hinge portions.

15. The USB device of claim 2, wherein the hinge unit is connected to the first case with a first portion and connected to the main body with a second portion.

16. The USB device of claim 1, wherein the main body has a terminal hole through which the second terminal portion extends.

17. The USB device of claim 1, further comprising a cam structure to fix a position of the USB terminal unit with respect to the main body.

18. The USB device of claim 1, wherein when the USB terminal unit is in an opened state with respect to the main body, the USB terminal unit makes contact with the main PCB to establish an electrical connection.

19. A universal serial bus (USB) device, comprising:
a main body to house a printed circuit board (PCB); and
a USB terminal unit rotatably connected to the main body via at least two hinge portions,
wherein, when the USB terminal unit is rotated from a closed state to an opened state, the USB terminal unit contacts the PCB to establish an electrical connection.

20. A universal serial bus (USB) device, comprising:
a main body to house a printed circuit board (PCB); and
a USB terminal unit rotatably connected to the main body, and comprising at least two hinge portions,
wherein a first hinge portion connects to the USB terminal unit and a second hinge portion connects to the main body, and
the USB terminal unit is rotatable from a closed state to an opened state to establish an electrical connection between the USB terminal and the PCB.
